(19) United States
(12) Patent Application Publication
(10) Pub. No.: US 2025/0217176 A1
(43) Pub. Date: Jul. 3, 2025

(54) VIRTUAL TERMINAL MAINTAINING A VIRTUAL TERMINAL STATE FOR A NEWLY CONNECTED CLIENT COMPUTER

(71) Applicant: Lenovo Enterprise Solutions (Singapore) Pte. Ltd., Singapore (SG)

(72) Inventors: Fred Allison Bower, III, Durham, NC (US); Shyam S. Sareen, Cary, NC (US); Jarrod B. Johnson, Raleigh, NC (US); Andrew Hamilton Wray, Hillsborough, NC (US)

(21) Appl. No.: 18/398,457

(22) Filed: Dec. 28, 2023

(51) Int. Cl. G06F 9/455

(52) U.S. Cl. CPC G06F 9/45558; G06F 2009/45579

(57) ABSTRACT

A service processor, computer program product and method include various operations. The operations include receiving a stream of serial data directed to be output through a virtual serial port of the service processor, wherein the stream of serial data identifies a plurality of parameters and a value for each parameter. The operations further include maintaining a virtual terminal state based on the serial data stream in the absence of an active connection of a client computer to the virtual serial port, wherein the virtual terminal state includes a most-recently received value for each parameter, and storing and updating the virtual terminal state in a screen buffer. Still further, the operations include outputting the virtual terminal state stored in the screen buffer through the virtual serial port to a client computer in response to detecting that the client computer has formed a new connection to the virtual serial port.

### BACKGROUND

The present disclosure relates to methods for a service processor to output a stream of serial data to a client computer.

### BACKGROUND OF THE RELATED ART

A baseboard management controller (BMC) is a central management component of a server that manages the interface between system management software and hardware devices installed in the server. For example, the BMC may be installed on the motherboard of the server, may monitor various types of sensors built into the server and may provide operational data and/or alerts to a system administrator over a network. A processor or CPU component of the BMC works independent of the host processor or CPU of the server.

A system administrator using a remote client computer may communicate with the BMC of a server over the network to obtain data and alerts reflecting the operation of the server and to provide instructions for taking corrective actions within the server. The remote client computer may run a web browser or virtual console program that renders a user interface on a display device, wherein the user interface contains the data and alerts on one or more screens or pages.

### BRIEF SUMMARY

Some embodiments provide a computer program product comprising a non-volatile computer readable medium and non-transitory program instructions embodied therein, the program instructions being configured to be executable by a service processor of a server to cause the service processor to perform various operations. The operations comprise receiving a stream of serial data directed to be output through a virtual serial port of the service processor, wherein the stream of serial data identifies a plurality of parameters and a value for each of the parameters. The operations further comprise maintaining a virtual terminal state based on the stream of serial data in the absence of an active connection of a client computer to the virtual serial port, wherein the virtual terminal state includes a most-recently received value for each of the plurality of parameters, and storing and updating the virtual terminal state in a screen buffer of the service processor. Still further, the operations comprise outputting the virtual terminal state stored in the screen buffer through the virtual serial port to a client computer in response to detecting that the client computer has formed a new connection to the virtual serial port.

Some embodiments provide a service processor comprising at least one non-volatile storage device storing program instructions and at least one processor configured to process the program instructions, wherein the program instructions are configured to, when processed by the at least one processor, cause the service processor to perform various operations. The operations comprise receiving a stream of serial data directed to be output through a virtual serial port of the service processor, wherein the stream of serial data identifies a plurality of parameters and a value for each of the parameters. The operations further comprise maintaining a virtual terminal state based on the stream of serial data in the absence of an active connection of a client computer to the virtual serial port, wherein the virtual terminal state includes a most-recently received value for each of the plurality of parameters, and storing and updating the virtual terminal state in a screen buffer of the service processor. Still further, the operations comprise outputting the virtual terminal state stored in the screen buffer through the virtual serial port to a client computer in response to detecting that the client computer has formed a new connection to the virtual serial port.

Some embodiments provide a method comprising a service processor receiving a stream of serial data directed to be output through a virtual serial port of the service processor, wherein the stream of serial data identifies a plurality of parameters and a value for each of the parameters; maintaining a virtual terminal state based on the stream of serial data in the absence of an active connection of a client computer to the virtual serial port, wherein the virtual terminal state includes a most-recently received value for each of the plurality of parameters; storing and updating the virtual terminal state in a screen buffer of the service processor; and outputting the virtual terminal state stored in the screen buffer through the virtual serial port to a client computer in response to detecting that the client computer has formed a new connection to the virtual serial port.

### BRIEF DESCRIPTION OF THE SEVERAL VIEWS OF THE DRAWINGS

FIG. 1 is a diagram of a system including a server having a baseboard management controller that performs the operations of a virtual terminal and a client computer forming a new connection to a virtual serial port of the baseboard management controller.

FIG. 2 is a diagram of a baseboard management controller according to some embodiments.

FIG. 3 is a diagram of one embodiment of a server.

FIG. 4 is a flowchart of operations performed by a service processor, such as a baseboard management controller.

### DETAILED DESCRIPTION

Some embodiments provide a computer program product comprising a non-volatile computer readable medium and non-transitory program instructions embodied therein, the program instructions being configured to be executable by a service processor of a server to cause the service processor to perform various operations. The operations comprise receiving a stream of serial data directed to be output through a virtual serial port of the service processor, wherein the stream of serial data identifies a plurality of parameters and a value for each of the parameters. The operations further comprise maintaining a virtual terminal state based on the stream of serial data in the absence of an active connection of a client computer to the virtual serial port, wherein the virtual terminal state includes a most-recently received value for each of the plurality of parameters, and storing and updating the virtual terminal state in a screen buffer of the service processor. Still further, the operations comprise outputting the virtual terminal state stored in the screen buffer through the virtual serial port to a client computer in response to detecting that the client computer has formed a new connection to the virtual serial port.

A service processor is a common component of computer hardware included in a server. A service processor may be implemented in the form of a baseboard management controller (BMC) but may include further features and functionality integrated with the baseboard management controller features and functionality. The service processor provides support for a virtual terminal program running on a client computer such that the virtual terminal program may have low-level access to the system firmware for debugging, configuration, and pre-provisioning. Embodiments disclosed herein provide the technical benefit of efficiently maintaining a virtual terminal state while no client computer is attached to a server such that the virtual terminal program running on a subsequently attached client computer initially receives enough information to display an accurate user interface reflecting what has transpired on the server.

A stream of serial data sends one bit of data at a time over a communication channel or connection. A transmitting side of the serial communication channel or connection may use a serializer to convert a byte or other unit of digital information into a stream of bits and a receiving side of the serial communication channel or connection may use a deserializer to convert the stream of bits into a byte or other unit of digital information. For example, a single ASCII character may be represented by an 8-bit (1 byte) string of bits, such that the 8-bit ASCII character is serialized and transmitted as stream of 8 bits and then deserialized upon receipt. In some embodiments, the stream of serial data includes data sent to the serial port by the operating system of the baseboard management controller, an operating system of the server, an application running on the baseboard management controller and/or an application running on the server. Such operating systems and application may send serial data to the virtual serial port of the baseboard management controller whether or not there is a client computer connected for communication with the virtual serial port.

The virtual terminal is a software or firmware component run by the service processor to emulate a physical terminal device. Optionally, the program instructions that cause the service processor to perform the operations of a virtual terminal may be included in the operating system used by the service processor. In a logical sense, the virtual terminal may be inserted on the virtual serial port feed of the service processor. The virtual terminal may therefore receive all serial data being sent or written to the virtual serial port whether or not a client computer is connected for communication with the virtual serial port. In one option, the virtual terminal may be logically disposed between an internal virtual serial port and the network outside the server so that the virtual terminal receives the output of the internal virtual serial port.

The virtual terminal may use the output received from the internal virtual serial port to create and store a virtual terminal state, where the virtual terminal state represents the content of a data screen as if the virtual terminal were a physical terminal or client computer that had been connected to the virtual serial port for an arbitrarily long period of time. The virtual terminal (software entity) may continuously interpret the data stream written to the virtual serial port of the service processor and store only the data necessary to reflect the current state of the virtual terminal (i.e., the virtual terminal state). The virtual terminal may be described as being “stateful” because it is designed to remember preceding data or events, where the remembered data or events are called the “state” of the virtual terminal. For example, the virtual terminal may maintain a state (i.e., store a most-recently received value) for each parameter associated with a user interface or screen. Accordingly, a virtual terminal program on the client computer that, in the future, becomes connected to the virtual serial port can be initialized with the complete contextual state of the terminal.

Note that the virtual terminal may continuously update the data stored in the screen buffer to maintain an accurate and current virtual terminal state. Embodiments of the virtual terminal store the virtual terminal state in the screen buffer (memory) with the technical benefit that the amount of data (i.e., number of bytes) necessary to render a single frame of a screen is less than the full stream of serial data that was received by the virtual terminal. Accordingly, if the screen buffer were a first-in-first-out (FIFO) then the screen buffer would need to have an unlimited size to avoid the possibility of dropping some portion of the serial data necessary to render one frame of the full screen. However, the memory for the screen buffer may be repurposed from an existing buffer of the service processor that may have been used as a FIFO buffer.

When a client computer establishes a new connection to the service processor, the virtual terminal may output the virtual terminal state stored in the screen buffer to an external virtual serial port for transmission to the client computer. The virtual terminal state provides the newly connected client computer (i.e., a new virtual terminal program connecting to the virtual serial port) with an accurate state of the contents of a screen as if the client computer had been connected to the virtual serial port for an arbitrarily long period of time. The attached client computer may use the virtual terminal state to display a user interface on a display screen using a web browser application or a virtual terminal program that is independent of a web browser. Because the virtual terminal is a logical module that may be considered to be embedded in an existing virtual serial port since the virtual terminal is run by the processor of the BMC with access to the server host memory locations where the host has registered the serial port IOs.

The program instructions (or “code”) that are run on the server side of the serial port terminal endpoint to which the virtual terminal is connected may serve as a bridge between a client computer and the rest of the operating system. If the serial port is connected to the baseboard management controller, then the program instructions running on the baseboard management controller allow the client computer to interact with the virtual terminal for the purpose of receiving and displaying various types of data from the operating system of the baseboard management controller. Similarly, if the serial port is connected to the host server, then the program instructions running as part of the host operating system to which the virtual terminal is connected may serve as the bridge to the rest of the operating system For example, the virtual terminal may allow the client computer to access and/or interact with one or more components of the operating system, such as process management, files management, command interpreter, system calls, signals, network management, security management, main memory management, secondary storage management, and input/output device management. Optionally, the virtual terminal may also allow the client computer to execute commands, run programs, and/or perform system management. Furthermore, the virtual terminal may be a component of an operating system that runs on the baseboard management controller.

In some embodiments, the operations may further comprise buffering additional serial data directed to the virtual serial port while the virtual terminal state stored in the screen buffer is being output to the virtual terminal program of the client computer, and then providing the virtual terminal program of the client computer with the buffered serial data in the order received. In one option, the additional serial data may be buffered in a separate buffer other than the screen buffer.

In some embodiments, the operations may further comprise, after outputting the virtual terminal state, forwarding any additional serial data received in the stream to the client computer through the connection to the virtual serial port in the order received without updating the virtual terminal state. While the virtual terminal state may enable the virtual terminal program on the client computer to render a complete screen that reflects the current contextual state of the virtual terminal, once the virtual terminal program has the virtual terminal state then the virtual terminal program may be provided with any additional serial data as it is written to the virtual serial port of the service processor. It is then the responsibility of the virtual terminal program to make marginal updates to the screen based on the stream of serial data subsequently received.

In some embodiments, the operations may further comprise temporarily ceasing to maintain the virtual terminal state for the duration of the active connection of the client computer to the virtual serial port. Since the virtual terminal program of the client computer is responsible for continued updating of the screen, the virtual terminal running on the service processor does not need to continue maintaining the virtual terminal state so long as there is an active connection. However, in a scenario where there may be rapid series of new connections to the virtual serial port, the virtual terminal may continue to maintain the virtual terminal state so as to always have a current virtual terminal state that can be shared with a new connection.

In some embodiments, the operation of outputting the virtual terminal state stored in the screen buffer may include the operation of converting the virtual terminal state stored in the screen buffer into a serial port byte stream. For example, the virtual terminal may convert the content of the screen buffer into a serial port byte stream in response to the service processor detecting that a virtual terminal program of a client computer has established a connection to the virtual serial port. The virtual terminal state that is output from the screen buffer preferably enables the client computer to display a user interface accurately reflecting the stream of serial data.

In some embodiments, the virtual terminal state includes the values necessary to render one or more frames of a screen without storing stale values that will not be rendered on the screen.

In some embodiments, the client computer runs a virtual terminal program or web browser that receives the virtual terminal state through the new connection with the virtual serial port to render a user interface as if the client computer had been connected to the virtual serial port for an arbitrarily long period of time.

In some embodiments, the operation of maintaining a virtual terminal state based on the stream of serial data includes the further operations of identifying a parameter and a new value for the parameter in the stream of serial data, and overwriting a previously-stored value for the parameter in the screen buffer with the new value for the parameter. For example, the virtual terminal may continuously update the values of each of the parameters stored in the screen buffer to only store the most-recently received value for each of the parameters.

Some embodiments provide a service processor comprising at least one non-volatile storage device storing program instructions and at least one processor configured to process the program instructions, wherein the program instructions are configured to, when processed by the at least one processor, cause the service processor to perform various operations. The operations comprise receiving a stream of serial data directed to be output through a virtual serial port of the service processor, wherein the stream of serial data identifies a plurality of parameters and a value for each of the parameters. The operations further comprise maintaining a virtual terminal state based on the stream of serial data in the absence of an active connection of a client computer to the virtual serial port, wherein the virtual terminal state includes a most-recently received value for each of the plurality of parameters, and storing and updating the virtual terminal state in a screen buffer of the service processor. Still further, the operations comprise outputting the virtual terminal state stored in the screen buffer through the virtual serial port to a client computer in response to detecting that the client computer has formed a new connection to the virtual serial port.

Embodiments of the service processor may perform any of the operations of the computer program product described herein. Conversely, any operation performed by the service processor may be included in the computer program product described herein.

Some embodiments provide a method comprising a service processor receiving a stream of serial data directed to be output through a virtual serial port of the service processor, wherein the stream of serial data identifies a plurality of parameters and a value for each of the parameters; maintaining a virtual terminal state based on the stream of serial data in the absence of an active connection of a client computer to the virtual serial port, wherein the virtual terminal state includes a most-recently received value for each of the plurality of parameters; storing and updating the virtual terminal state in a screen buffer of the service processor; and outputting the virtual terminal state stored in the screen buffer through the virtual serial port to a client computer in response to detecting that the client computer has formed a new connection to the virtual serial port.

In some embodiments of the method, outputting the virtual terminal state stored in the screen buffer may include converting the virtual terminal state stored in the screen buffer into a second stream of serial data.

In some embodiments, the method may further comprise a virtual terminal program that is running on the client computer receiving the second stream of serial data through the new connection to the virtual serial port and causing a user interface containing the virtual terminal state to be displayed.

Embodiments of the method may further include any operations or steps of the computer program product and/or service processor described herein. Conversely, any operation or step described by a method may be included as an operation of the computer program product or service processor unless specifically identified as an operation or step of the client computer.

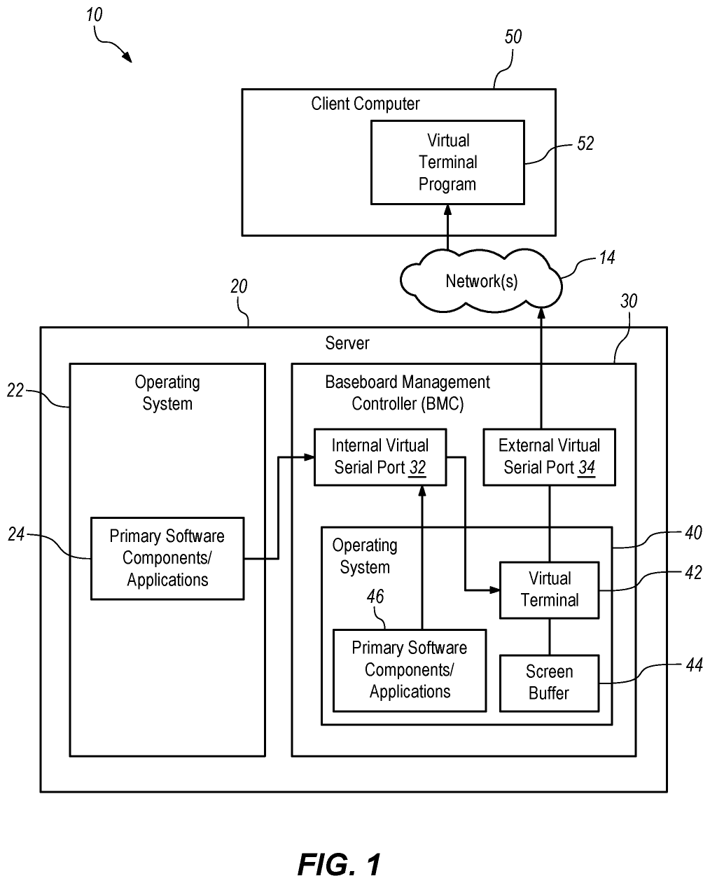

FIG. 1 is a diagram of a system 10 including a server 20 having a baseboard management controller (or other service processor) 30 that performs the operations of a virtual terminal and a client computer 50 forming a new connection to a virtual serial port of the baseboard management controller. The baseboard management controller 30 includes a processor (not shown) that runs an operating system 40 and a virtual serial port. Optionally, the virtual serial port may be implemented as an internal virtual serial port 32 and an external virtual serial port 34. For example, the internal virtual serial port 32 may receive a stream of serial data from the operating system 22 or applications running on a central processing unit of the server 20 and/or from the operating system 40 or application running on the baseboard management controller 40. More specifically, the internal virtual serial port 32 may receive serial data from one or more primary software components 24 of the operating system 22 and/or applications running on a central processing unit of the server 20. Furthermore, the internal virtual serial port 32 may receive serial data from one or more primary software components 46 of the operating system 40 running on a central processing unit of the baseboard management controller 30.

The virtual terminal 42 may obtain the serial data received at the internal virtual serial port 32 and store a virtual terminal state in the screen buffer 44. When a virtual terminal program 52 or web browser running on the client computer 50 establishes a new connection with the external virtual serial port 34, the virtual terminal 42 may convert the virtual terminal state data stored in the screen buffer 44 to a second serial data stream and output that second serial data stream to the external virtual serial port 34 for forwarding to the virtual terminal program 52 over the network(s) 14.

The virtual terminal 42 is implemented as program instructions executable by a central processing unit of the baseboard management controller 30. Embodiments may provide a computer program product comprising a non-volatile computer readable medium and non-transitory program instructions embodied therein, where the program instructions are configured to be executable by the service processor of a server, such as the central processing unit of a baseboard management controller, to cause the service processor to perform various operations. Optionally, the program instructions that cause the service processor to perform the operations of the virtual terminal 42 may be included in the computer program product of the operating system 40.

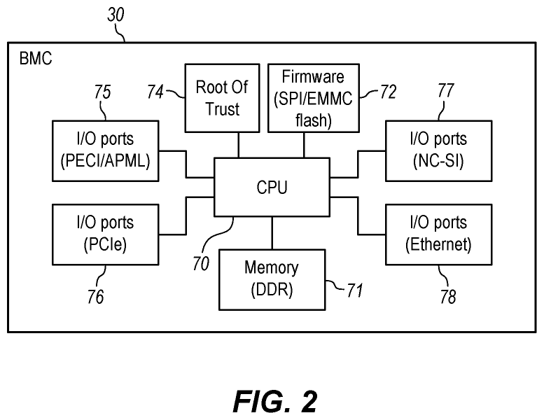

FIG. 2 is a diagram of a baseboard management controller (BMC) 30 according to some embodiments. The BMC 30 is similar to a small computer or system on a chip (SoC), including a central processing unit (CPU) 70, memory 71 (such as random-access memory (RAM) on a double data rate (DDR) bus), firmware 72 on a flash memory (such as an embedded multi-media card (eMMC) flash memory or a serial peripheral interface (SPI) flash memory), and a root of trust (RoT) chip 74. The BMC 30 further includes a wide variety of input/output ports. For example, the input/output (I/O) ports may include I/O ports 75 to the hardware components of the server, such as a Platform Environment Control Interface (PECI) port and/or an Advanced Platform Management Link (APML) port; I/O ports 76 to the hardware components of the servers and/or the network interface controller (NIC), such as a Peripheral Component Interconnect Express (PCIe) port; I/O ports 77 to the NIC, such as a network controller sideband interface (NC-SI) port; and I/O ports 78 to a network that accessible to an external user, such as an Ethernet port. One or more of the I/O ports may be a serial port for carrying output from the virtual serial port of the BMC.

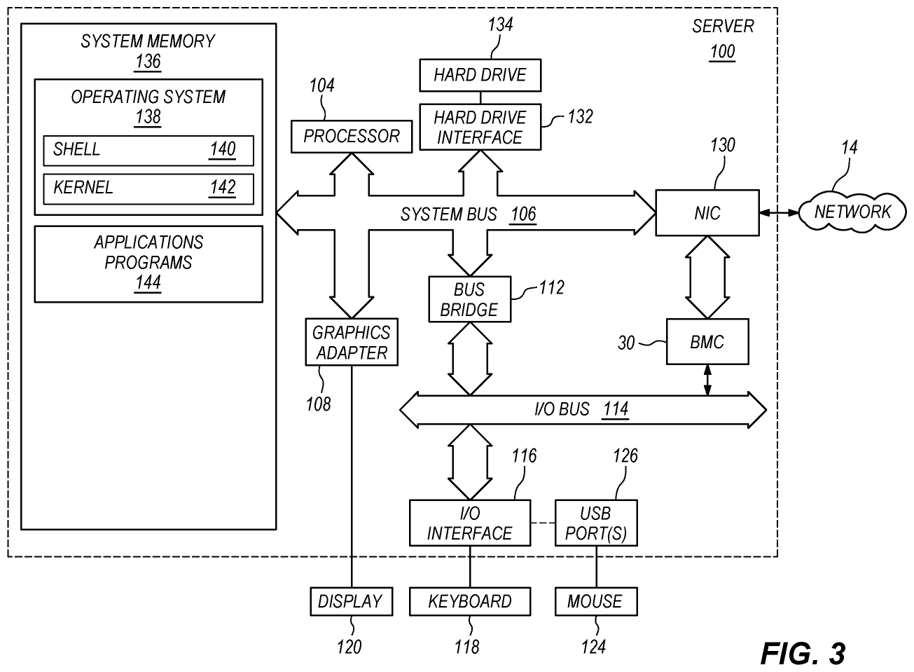

FIG. 3 is a diagram of one embodiment of a server 100 that may be representative, but not limiting, of the configuration of the server 20 of FIG. 1. The server 100 includes a processor unit 104 that is coupled to a system bus 106. The processor unit 104 may utilize one or more processors, each of which has one or more processor cores. A graphics adapter 108, which drives/supports the display 120, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, such as a keyboard 118 (perhaps as a touch screen virtual keyboard), and a USB mouse 124 via USB port(s) 126 (or other type of pointing device, such as a trackpad). The I/O bus 114 may also provide communication to the BMC 30. As depicted, the server 100 may communicate with other devices over the network 14 using a network adapter or network interface controller (NIC) 130, which may be the Smart NIC 40 (see FIGS. 1 and 2). The hardware elements depicted in the server 100 are not intended to be exhaustive, but rather are representative. For instance, the server 100 may include non-volatile memory and the like.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as the lowest level of volatile memory in the computer 100. This volatile memory may include additional higher levels of volatile memory (not shown), including, but not limited to, cache memory, registers and buffers. Data that populates the system memory 136 may include an operating system (OS) 138 and application programs 144. Embodiments may include an application program that generates a stream of serial data to a client computer on the network 14 via the BMC 30 and the NIC 130.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 140 may be a text-based, line-oriented user interface, embodiments may support other user interface modes, such as graphical, voice, gestural, etc.

As depicted, the operating system 138 also includes the kernel 142, which may include lower levels of functionality for the operating system 138, including providing essential services required by other parts of the operating system 138 and application programs 144. Such essential services may include memory management, process and task management, disk management, and mouse and keyboard management. As shown, the server 100 includes application programs 144 in the system memory of the server 100.

The server 100 further includes the baseboard management controller (BMC) 30. The BMC may be used to perform out-of-band processing and may monitor and manage various features of the hardware components of the server. Furthermore, the BMC 32 may run and/or be responsible for performing the operations of a virtual terminal, including maintaining a virtual terminal state in a screen buffer within the BMC.

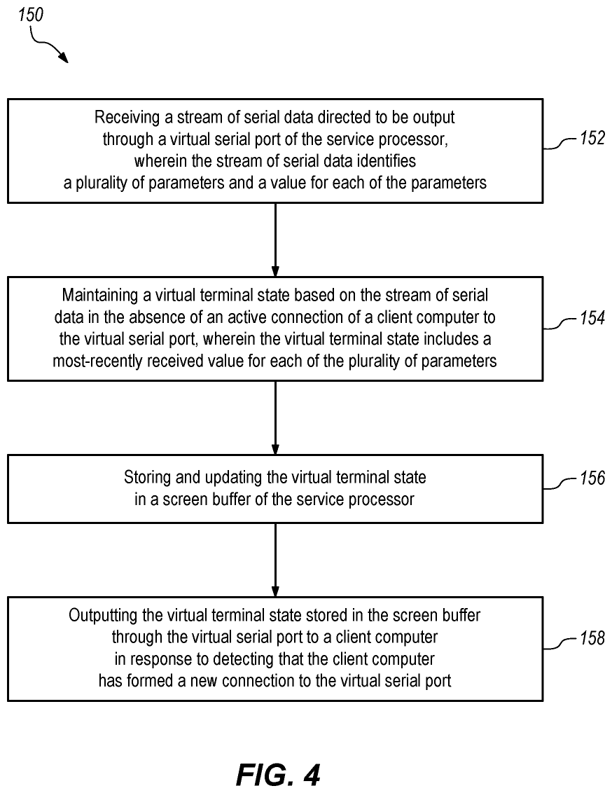

FIG. 4 is a flowchart of operations 150 according to some method or computer program product embodiments. Operation 152 includes receiving a stream of serial data directed to be output through a virtual serial port of the service processor, wherein the stream of serial data identifies a plurality of parameters and a value for each of the parameters. Operation 154 includes maintaining a virtual terminal state based on the stream of serial data in the absence of an active connection of a client computer to the virtual serial port, wherein the virtual terminal state includes a most-recently received value for each of the plurality of parameters. Operation 156 includes storing and updating the virtual terminal state in a screen buffer of the service processor. Operation 158 includes outputting the virtual terminal state stored in the screen buffer through the virtual serial port to a client computer in response to detecting that the client computer has formed a new connection to the virtual serial port.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-volatile computer readable medium and non-transitory program instructions embodied therein, the program instructions being configured to be executable by a service processor of a server to cause the service processor to perform operations comprising:
receiving a stream of serial data directed to be output through a virtual serial port of the service processor, wherein the stream of serial data identifies a plurality of parameters and a value for each of the parameters;
maintaining a virtual terminal state based on the stream of serial data in the absence of an active connection of a client computer to the virtual serial port, wherein the virtual terminal state includes a most-recently received value for each of the plurality of parameters;
storing and updating the virtual terminal state in a screen buffer of the service processor; and
outputting the virtual terminal state stored in the screen buffer through the virtual serial port to a client computer in response to detecting that the client computer has formed a new connection to the virtual serial port.

2. The computer program product of claim 1, the operations further comprising:
after outputting the virtual terminal state, forwarding any additional serial data received in the stream to the client computer through the connection to the virtual serial port in the order received without updating the virtual terminal state.

3. The computer program product of claim 1, the operations further comprising:
buffering additional serial data directed to the virtual serial port while the virtual terminal state stored in the screen buffer is being output to the virtual terminal program of the client computer; and then
providing the virtual terminal program of the client computer with the buffered serial data in the order received.

4. The computer program product of claim 3, wherein the additional serial data is buffered in a separate buffer other than the screen buffer.

5. The computer program product of claim 1, the operations further comprising:
temporarily ceasing to maintain the virtual terminal state for the duration of the active connection of the client computer to the virtual serial port.

6. The computer program product of claim 1, the operations further comprising:
continuing to maintain the virtual terminal state during the active connection of the client computer to the virtual serial port.

7. The computer program product of claim 1, wherein outputting the virtual terminal state stored in the screen buffer includes converting the virtual terminal state stored in the screen buffer into a serial port byte stream.

8. The computer program product of claim 1, wherein the service processor is a baseboard management controller.

9. The computer program product of claim 1, wherein the virtual terminal state that is output from the screen buffer enables the client computer to display a user interface accurately reflecting the stream of serial data.

10. The computer program product of claim 1, wherein the virtual terminal stores data in the screen buffer as if the virtual terminal was a physical terminal that had been connected to the virtual serial port to receive the stream of serial data.

11. The computer program product of claim 1, wherein the virtual terminal state includes values necessary to render one or more frame of a screen without storing stale values that will not be rendered on the screen.

12. The computer program product of claim 1, wherein the client computer runs a virtual terminal program that receives the virtual terminal state through the new connection with the virtual serial port to render a user interface as if the client computer had been connected to the virtual serial port for an arbitrarily long period of time.

13. The computer program product of claim 1, wherein the operation of maintaining a virtual terminal state based on the stream of serial data includes:
identifying a parameter and a new value for the parameter in the stream of serial data; and
overwriting a previously stored value for the parameter in the screen buffer with the new value for the parameter.

14. The computer program product of claim 1, wherein the virtual terminal continuously updates the values of each of the parameters stored in the screen buffer to only store the most-recently received value for each of the parameters.

15. The computer program product of claim 1, wherein the service processor includes memory that is used for the screen buffer.

16. The computer program product of claim 1, wherein the stream of serial data includes data sent to the serial port by the operating system of the baseboard management controller, an operating system of the server, an application running on the baseboard management controller and/or an application running on the server.

17. A service processor, comprising:
at least one non-volatile storage device storing program instructions; and
at least one processor configured to process the program instructions,
wherein the program instructions are configured to, when processed by the at least one processor, cause the service processor to perform operations comprising:
receiving a stream of serial data directed to be output through a virtual serial port of the service processor, wherein the stream of serial data identifies a plurality of parameters and a value for each of the parameters;
maintaining a virtual terminal state based on the stream of serial data in the absence of an active connection of a client computer to the virtual serial port, wherein the virtual terminal state includes a most-recently received value for each of the plurality of parameters;
storing and updating the virtual terminal state in the at least one non-volatile storage device; and
outputting the virtual terminal state stored in the at least one non-volatile storage device through the virtual serial port to a client computer in response to detecting that the client computer has formed a new connection to the virtual serial port.

18. The service processor of claim 17, wherein the operations further comprise:
after outputting the virtual terminal state, forwarding any additional serial data received in the stream to the client computer through the connection to the virtual serial port in the order received without updating the virtual terminal state.

19. A method, comprising:
a service processor receiving a stream of serial data directed to be output through a virtual serial port of the service processor, wherein the stream of serial data identifies a plurality of parameters and a value for each of the parameters;
maintaining a virtual terminal state based on the stream of serial data in the absence of an active connection of a client computer to the virtual serial port, wherein the virtual terminal state includes a most-recently received value for each of the plurality of parameters;
storing and updating the virtual terminal state in a screen buffer of the service processor; and
outputting the virtual terminal state stored in the screen buffer through the virtual serial port to a client computer in response to detecting that the client computer has formed a new connection to the virtual serial port.

20. The method of claim 19, wherein outputting the virtual terminal state stored in the screen buffer includes converting the virtual terminal state stored in the screen buffer into a second stream of serial data, further comprising:
a virtual terminal program that is running on the client computer receiving the second stream of serial data through the new connection to the virtual serial port and causing a user interface containing the virtual terminal state to be displayed.
